(19) United States
(12) Patent Application Publication
(10) Pub. No.: US 2020/0170216 A1
(43) Pub. Date: Jun. 4, 2020

(54) Pet Bed

(71) Applicant: Stacey Ferguson, Cantonment, FL (US)

(72) Inventor: Stacey Ferguson, Cantonment, FL (US)

(21) Appl. No.: 16/205,203

(22) Filed: Nov. 29, 2018

(51) Int. Cl. A01K 1/035

(52) U.S. Cl. CPC A01K 1/0353; B68G 5/00

(57) ABSTRACT

A bed for dogs, cats, and other domesticated animals having a top layer and a bottom layer filled with flexible stuffing material. The top layer of the pet bed comprises of an internal padded foam.

### CROSS-REFERENCE TO RELATED APPLICATION

This application claims priority to U.S. Provisional Application No. 62/591,838 filed on Nov. 29, 2017, the disclosure of which, including any materials incorporated by reference therein, is incorporated herein by reference in its entirety.

### TECHNICAL FIELD

The present invention relates generally to a pet accessory. More particularly, the present invention concerns a bean bag dog bed.

### BACKGROUND

Many pets utilize their own beds. Dogs in particular make use of dog beds. These typically square or round beds are generally configured for use by dogs in that they are easy to access, are low to the ground, and are sturdy. However, conventional dog beds are stuffed with foam or another comparable material. Such materials may break down over time, and are generally not optimally comfortable for dogs. By contrast, bean bag chairs are known to be resilient and extremely comfortable when used by humans. A need therefore exists for a dog bed that has the useful properties of typical dog beds while possessing the added advantage of a bean bag-filled interior cushion.

Attempts have been made, although unsuccessfully, to solve this problem. One illustrative attempt can be seen with respect to U.S. Patent Application Publication No. 2008/0127897, incorporated by reference in its entirety herein, which generally discloses a pet bed having a collapsible frame that, when extended, lifts the dog bed a certain distance above the ground. While this disclosure does provide for an elevated and enhanced dog bed, it fails to provide for bean bag-material inside the dog bed.

Another attempt to meet this need can be seen with respect to U.S. Pat. No. 5,685,257, incorporated by reference in its entirety herein, which generally discloses a hypoallergenic and multi-layered dog bed. Although this disclosure does provide for advanced dog bed construction, it also fails to provide for a bean bag-type dog bed cushion.

Another attempt can be seen with respect to U.S. Pat. No. 5,363,804, incorporated by reference in its entirety herein, which generally discloses a pet bed composed of heat-treated layers. While this pet bed's cushion is presumably resilient, it lacks the properties of a bean bag dog bed.

As can be seen, various attempts have been made to solve the problems which may be found in the related art but have been unsuccessful. A need exists for a new bean bag dog bed to avoid the challenges and problems with the prior art.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed by name, such as a bed, cushion, pet, etc., are herein meant to include or encompass all equivalents for such elements. Such equivalents are contemplated for each element named in its particular herein.

Moreover, any item, person, object, or thing capable of being retained within the present invention may herein be referred to herein as a “bed,” including a mattress, pallet, platform, cot, bunk, and so forth.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel solution for enhancing pet comfort. The general purpose of the present invention, which shall be described subsequently in greater detail, is to enable a dog (or other animal or user) to recline on a bean bag pad and enjoy the uniquely comfortable and supportive benefits of a bean bag-type cushion. The features of the invention are believed to be novel and to have been particularly pointed out and distinctly claimed in the concluding portion of the specification. These and other features, aspects, and advantages of the present invention will become better understood with reference to the following drawing and detailed description.

The features of the invention which are believed to be novel are particularly pointed out and distinctly claimed in the concluding portion of the specification. By way of non-limiting example, the present invention provides a novel solution for a new bean bag dog bed. These and other features, aspects, and advantages of the present invention will become better understood with reference to the following drawings and detailed description.

The present invention comprises a bean bag dog bed. In some embodiments, the present invention provides for a cushion configured for use by a human or animal, such as by way of example a dog, wherein the cushion is stuffed with bean bag tiller (or “biggie bean bag filler poly-fil”). In some embodiments, the cushion may be washable or machine washable. In one or more embodiments, the cushion may provide for one or more zippers or other such opening and closing elements in or on the cushion that may enable a user to remove the bean bag tiller from within the cushion. In some embodiments, two or more units of bean bag tiller may fill the interior of the cushion. In various embodiments, either or both of the cushion or the bean bag tiller may be of various sizes so as to accommodate different numbers or sizes of animal-users.

In some embodiments, the present invention may provide for an outer layer (or “cover”) that surrounds the cushion. The outer layer may also, in some embodiments, be removable and washable. The outer layer may be partly or entirely single stitched, double-stitched, triple-stitched, quadruple-stitched, or provide for any number of stitches or stitching. The outer layer may, in some embodiments, be composed of polyester, 100% polyester, cotton, linen, satin, a blend of fabrics, or any other fabric capable of use by the present invention. In some embodiments, the present invention may provide for one or more zippers on the outer layer that enable the cushion to be removed from within the outer layer. The one or more zippers may be exposed, hidden, or partly hidden. In a range of embodiments, the outer layer may be of any of a number of sizes selected to accommodate any number or size of animals. The cover may also provide for one or more designs, such as a sports team logo, bones or paw-print designs, a personalized name or picture, a raised or recessed portion, any pretty design, or provide for any other decorative surface feature known in the art.

The present invention may provide for one or more additional layers or cushions within a layer. For example, the present invention may provide for two or more cushions stuffed with bean bag filler to be contained within a cover. In some embodiments, two or more covers may be provided. In some embodiments, one or more cushions may be filled with an alternative to bean bag filler, such as foam. In some embodiments, buttons or hook and loop fasteners may be provided in place of or in alternative to one or more zippers. In some embodiments, the present invention may provide for a base upon which the cushion and/or the cover rest. Such a base may be any known in the art. In some embodiments, the present invention may be large, so as to accommodate any size animal, or small, so as to accommodate a small animal or bird .

The unique features of this product will provide the following benefits for consumers everywhere: it is affordable and convenient; cozy and soft; machine washable, resistant to normal wear and tear; odor resistant; and highly durable.

The embodiments of the invention described herein are exemplary and numerous modifications, variations and rearrangements can be readily envisioned to achieve substantially equivalent results, all of which are intended to be embraced within the spirit and scope of the invention. Furthermore, while the preferred embodiment of the invention has been described in terms of the components and configurations, it is understood to that the invention is not intended to be limited to those specific dimensions or configurations but is to be accorded the full breadth and scope of the spirit of the invention.

### BRIEF DESCRIPTION OF THE DRAWINGS

These and other features, aspects and advantages of the present invention will become better understood with regard to the following description, appended claims, and accompanying figures where:

FIG. 1 shows a top planar view of a bean bag dog bed in accordance with an embodiment of the invention.

FIG. 2 shows a perspective view of a bean bag dog bed in accordance with an embodiment of the invention.

FIG. 3 shows a first side view of a bean bag dog bed in accordance with an embodiment of the invention.

### DETAILED DESCRIPTION

The present invention overcomes the limitations of the prior art by providing a new and more effective bean bag dog bed.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising,” “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well- known features, elements or techniques may not be shown in detail in order not to obscure the embodiments.

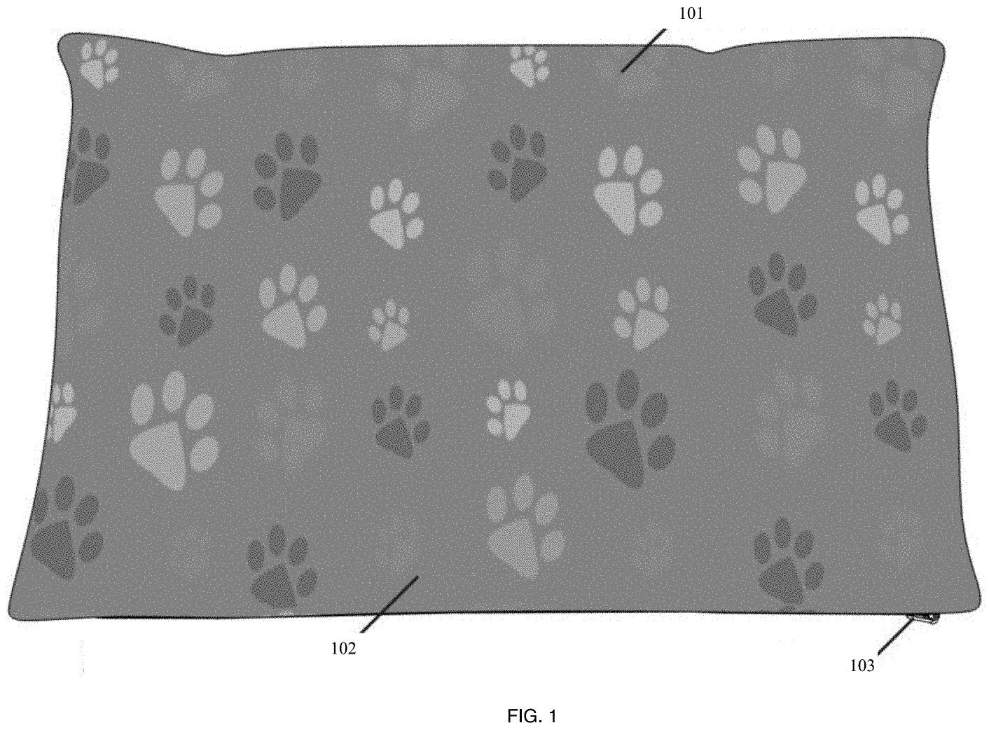

Turning attention to FIG. 1, a top planar view of a bean bag dog bed accordance with an embodiment of the invention is shown. In the embodiment depicted, a viewer may perceive a bean bag bed 101 for use as a bed for a dog, cat, or other domesticated pet. In general, the bean bag bed 101 comprises a central resting area 102 that is covered in fabric or some other breathable covering material. The bean bag bed 101 has an mass of stuffing (not shown) that is secured and enclosed within the walls of the bean bag bed 101 with a zipper 103 on the side wall of the bean bag bed 101.

As may be noted by those of skill in the art, the bean bag bed 101 need not be generally rectangular as shown in FIG. 1, but rather in some embodiments central compartment 101 may be circular, triangular, square or any other shape. Moreover, central compartment 101 may be deeper or shallower, taller or shorter, or generally of another carrying capacity than generally disclosed in FIG. 1. Additionally, in some embodiments, the bean bag bed 101 may provide for one or more inner compartments (not shown) that may be generally configured, or that may be specially configured, such as but not limited to configured to hold toys or any other object or item.

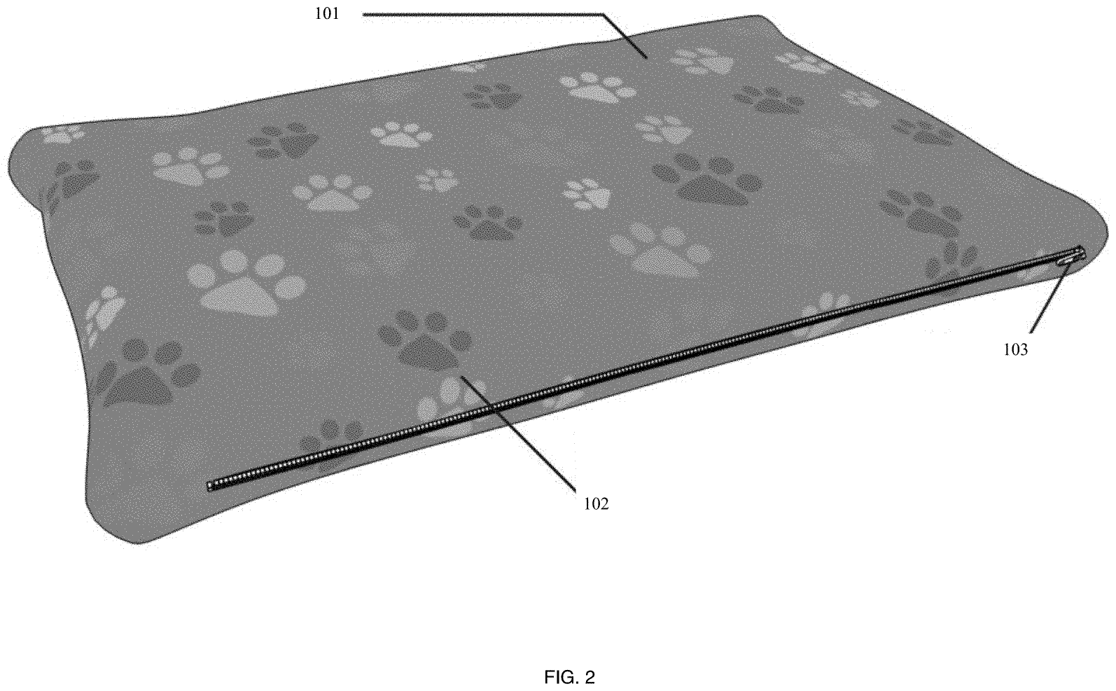

With respect to FIG. 2, a front perspective view of a bean bag dog bed in accordance with an embodiment of the invention is shown. In the embodiment depicted, a viewer may perceive the bean bag bed 101 a central resting area 102 with a mass of stuffing (not shown) that is secured and enclosed with a zipper 103 on the side wall of the bean bag bed 101.

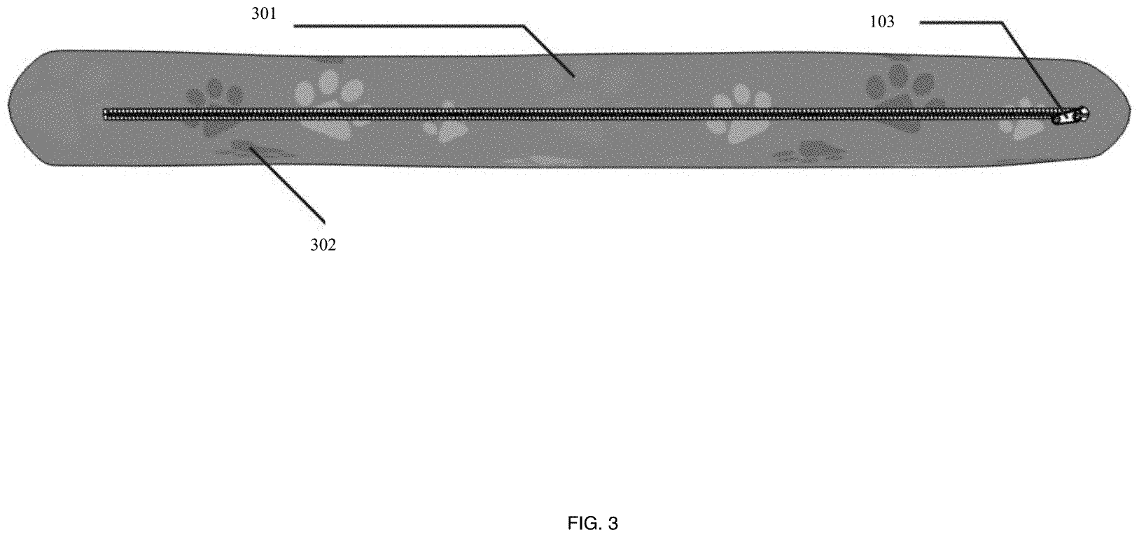

With regards to FIG. 3, a first side elevational view of a bean bag bed in accordance with an embodiment of the invention is shown. In the embodiment depicted, a viewer may perceive the enclosed zipper 103 resting between a top member 301 and a bottom member 302 of the bean bag bed 101.

The top member 301 of the bean bag bed 101 comprises of an inner honeycomb bubble cushion layer throughout the entire top member 301 (not shown) to provide support for the resting pets joints, spine, and hips, and may be comprised of any material known in the art, such as but not limited to nylon, polyester, or any synthetic fiber; silk, cotton, bamboo or any other natural fiber, rayon or any semi-synthetic fiber, metal, or any other material. The bottom member 302 of the bean bag bed 101 comprises of a an inner foam (not shown) to provide additional support.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the present invention generally described herein has been disclosed in connection with a number of embodiments shown and described in detail, various modifications should be readily apparent to those of skill in the art.

What is claimed is:

1. A pet bed comprising:
a bottom panel of flexible material;
at least four elongated side panels extending around the peripheral edge of the bottom panel and joined thereto wherein the side panel has an upper edge substantially parallel to the lower edge a top panel of flexible material similar in size and shape to the bottom panel having a peripheral edge portion joined to the upper edges of the side panels
an annual mass of stuffing material disposed between the top and bottom panels.

2. The pet bed of claim 1, wherein at least one side panel joins the top panel and bottom panel with an interlocking fastener, such as a zipper.

3. The pet bed of claim 1, wherein the inner facing side of the top panel is composed of a padded foam.

4. The pet bed of claim 3, wherein the padded foam is comprised of air bubbles.
